(19) United States
(12) Patent Application Publication
(10) Pub. No.: US 2024/0355535 A1
(43) Pub. Date: Oct. 24, 2024

(54) COIL ELECTRONIC COMONENT

(71) Applicant: SAMSUNG ELECTRO-MECHANICS CO., LTD., Suwon-si (KR)

(72) Inventors: Juhwan Yang, Suwon-si (KR); Byeongcheol Moon, Suwon-si (KR); Su Min Seo, Suwon-si (KR); Boumseock Kim, Suwon-si (KR); Jae-Hun Kim, Suwon-si (KR)

(73) Assignee: SAMSUNG ELECTRO-MECHANICS CO., LTD., Suwon-si (KR)

(21) Appl. No.: 18/442,636

(22) Filed: Feb. 15, 2024

(30) Foreign Application Priority Data
Apr. 20, 2023 (KR) 10-2023-0052055

(51) Int. Cl. H01F 27/29; H01F 5/04

(52) U.S. Cl. CPC H01F 27/292; H01F 5/04

(57) ABSTRACT

A coil electronic component includes a main body including a magnetic material, a wound coil of which at least a part is embedded in the main body, and a first and second lead terminals connected to both end portions of the wound coil, respectively, where in a cross-section perpendicular to a width direction of the main body, a first distance D1, which is a distance between an end surface of the main body in a length direction and an outermost turn coil of the wound coil, measured along the length direction of the main body at a half point of a thickness T1 of the main body, is greater than or equal to 2% and smaller than or equal to 7.5% of a length L1 of the main body in the length direction.

### CROSS-REFERENCE TO RELATED APPLICATION

This application claims priority to and the benefit of Korean Patent Application No. 10-2023-0052055 filed on Apr. 20, 2023 in the Korean Intellectual Property Office, the entire contents of which is incorporated herein by reference.

### BACKGROUND

### Field

The present disclosure relates to a coil electronic component.

### Description of the Related Art

Recently, as the functions of mobile devices diversify, power consumption increases, and in order to increase battery usage time in mobile devices, passive components with low loss and excellent efficiency are adopted around a power management integrated circuit (PMIC). Meanwhile, there is a growing demand for a low profile power inductor in order to slim down products and increase a degree of freedom in component arrangement.

Power inductors may be roughly categorized into multilayer, thin-film, and wire-wound types based on their structure and manufacturing method. In the case of wire-wound type inductors, securing capacity versus volume may be insufficient because the gap between the end surface of the main body in the length direction and the coil is large. In addition, in a structure in which the external electrodes are disposed on the lower surface of the main body, when the external electrodes are exposed to the longitudinal end of the main body, the risk of short circuit occurrence during mounting on a substrate may increase.

### SUMMARY

One aspect of an embodiment is to provide a coil electronic component with increased capacity versus volume.

Another aspect of the embodiment is to provide a coil electronic component that reduces the possibility of short circuit when mounted on a circuit board.

However, the objective of the present disclosure is not limited to the aforementioned one, and may be extended in various ways within the spirit and scope of the present disclosure.

A coil electronic component includes a main body including a magnetic material, a wound coil of which at least a part is embedded in the main body, and first and second lead terminals connected to both end portions of the wound coil, respectively, where in a cross-section perpendicular to a width direction of the main body, a first distance D1, which is a distance between an end surface of the main body in a length direction and an outermost turn coil of the wound coil, measured along the length direction of the main body at a half point of a thickness T1 of the main body, is greater than or equal to 2% and smaller than or equal to 7.5% of a length L1 of the main body in the length direction.

The main body may further include a first surface and a second surface spaced apart from each other along a thickness direction. The wound coil may include a first coil surface facing the first surface and a second coil surface facing the second surface of the main body. The first and second lead terminals may be disposed on the second surface of the main body. A second distance D2, which may be a distance between the first surface of the main body and the first coil surface, may be different from a third distance D3, which may be a distance between the second coil surface and the first and second lead terminals.

The second distance D2 may be smaller than the third distance D3.

Each of the first and second lead terminals may include a first electrode surface and a second electrode surface spaced apart from each other along the thickness direction of the main body, and

The second electrode surface is in contact with the second surface of the main body.

The second electrode surface may be exposed from the second surface of the main body.

The third distance D3 may be a distance between the second coil surface and the first electrode surface.

Each of the first and second lead terminals may include a third electrode surface that connects the first electrode surface and the second electrode surface. The third electrode surface may face an end surface of the main body in the length direction and be disposed apart from the end surface by a fourth distance D4.

The fourth distance D4 may be larger than the first distance D1.

At least a part of remaining surfaces of the first and second lead terminals connected to the second electrode surface may be embedded in an interior of the main body.

The wound coil may include N turns, where N is a natural number greater than or equal to 1. The second distance D2 may be an arithmetic average value obtained by measuring distances between three points on the first coil surface of a coil corresponding to each turn and the first surface of the main body.

The third distance D3 may be an arithmetic average value obtained by measuring distances between three points on the second coil surface of a coil corresponding to each turn and the first and second lead terminals.

The wound coil may include a first coil and a second coil that is connected to the first coil and stacked on the first coil. The second distance D2 may be a distance between the first surface of the main body and the first coil surface of the second coil. The third distance D3 may be a distance between the second coil surface of the first coil and the first and second lead terminals.

The number of turns of the first coil and the number of turns of the second coil may be the same.

The number of turns of the first coil and the number of turns of the second coil may be different.

The magnetic material may include metallic magnetic particles, and the metallic magnetic particles may include two or more powder particles having different compositions.

The metallic magnetic particles may include iron (Fe).

The coil electronic component may further include first and second external electrodes disposed on surfaces of the first and second lead terminals, respectively, and electrically connected to the first and second lead terminals, respectively.

The first and second external electrodes may further extend from the surfaces of the first and second lead terminals onto the second surface of the main body.

A recess portion may be formed on the second surface of the main body in an area between the first and second external electrodes.

The wound coil may include an innermost turn coil and an intermediate turn coil that are in contact with each other and have different heights measured from the second surface of the main body.

According to a coil electronic component an embodiment, the capacity versus volume may be increased by reducing the distance between the longitudinal end surface of the main body and the coil.

In addition, according to a coil electronic component an embodiment, the thickness of the lower cover layer is greater than the thickness of the upper cover layer and the land pattern of the lead terminal is disposed inside the body, thereby reducing the risk of short circuit while being mounted on the circuit board.

### BRIEF DESCRIPTION OF THE DRAWINGS

FIG. 1 is a perspective view schematically illustrating a coil electronic component according to an embodiment.

FIG. 2 is a top plan view illustrating a base portion of the coil electronic component of FIG. 1.

FIG. 3 is a bottom perspective view illustrating a base portion of the coil electronic component of FIG. 1.

FIG. 4A and FIG. 4B is a cross-sectional view taken along line II-II′ of FIG. 1.

FIG. 5A and FIG. 5B are cross-sectional views schematically illustrating a coil electronic component according to another embodiment.

FIG. 6 is a cross-sectional view schematically illustrating the coil electronic component shown in FIG. 1 mounted on a circuit board.

### DETAILED DESCRIPTION OF THE EMBODIMENTS

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including an ordinal number, such as first, second, etc., may be used to describe various elements, but the elements are not limited by the terms. The terms are only used to differentiate one constituent element from other constituent elements.

In addition, it will be understood that when an element such as a layer, film, region, area, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

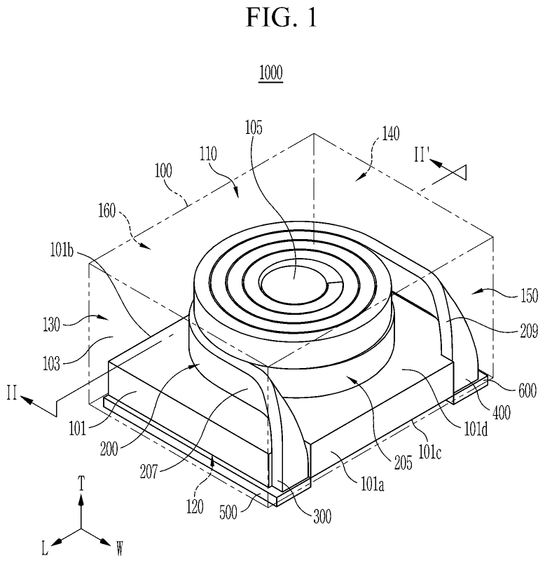

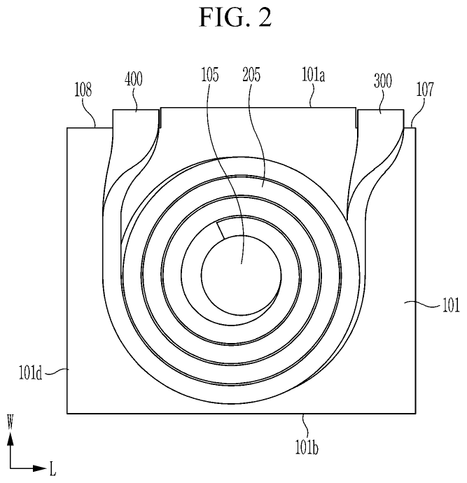

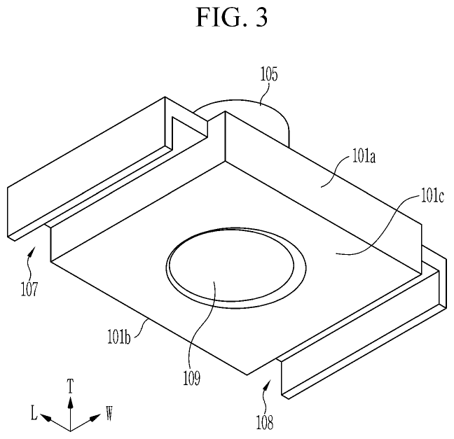

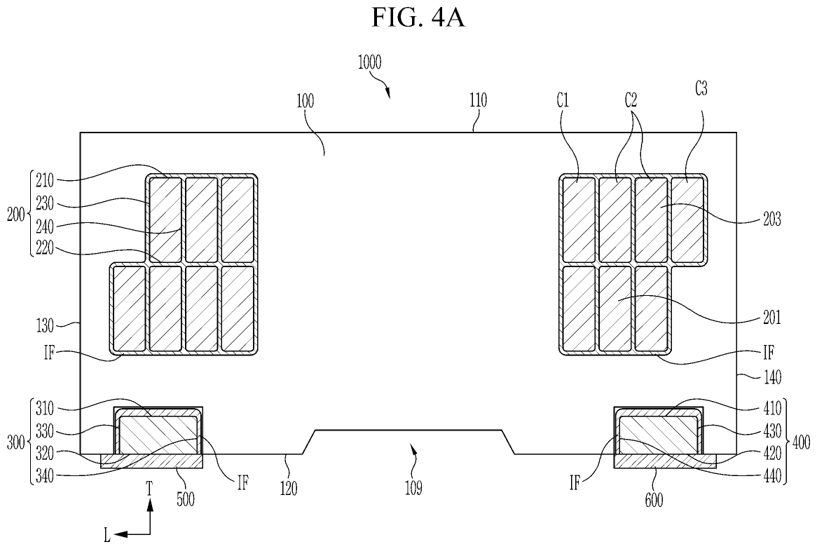

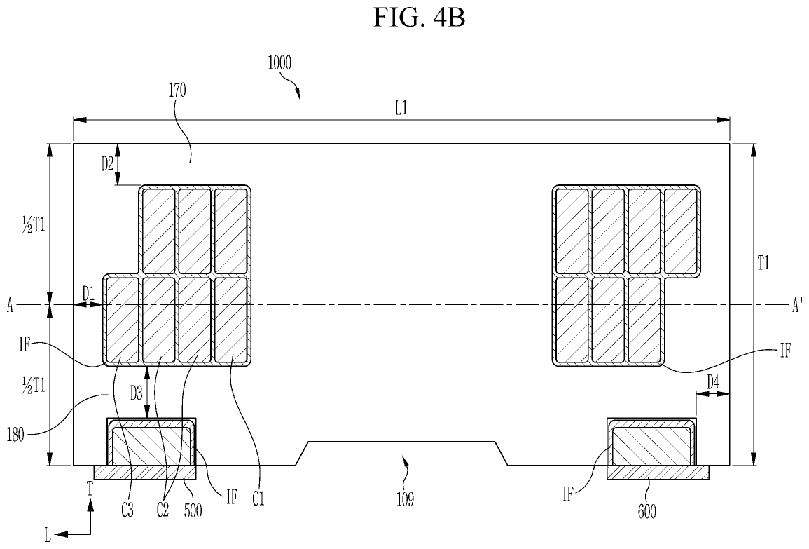

FIG. 1 is a perspective view schematically illustrating a coil electronic component according to an embodiment. FIG. 2 is a top plan view illustrating a base portion of the coil electronic component of FIG. 1. FIG. 3 is a bottom perspective view illustrating a base portion of the coil electronic component of FIG. 1. FIG. 4A and FIG. 4B is a cross-sectional view taken along line II-II′ of FIG. 1.

Referring to FIG. 1, FIG. 2, FIG. 3, FIG. 4A and FIG. 4B, a coil electronic component 1000 according to an embodiment includes a main body 100, a wound coil 200, a first external electrode 500 and a second external electrode 600.

The main body 100 may have a substantially hexahedral shape, but the present embodiment is not limited thereto. Due to shrinkage of the magnetic powder or the like during sintering, the main body 100 may have a substantially hexahedral shape, although not a perfect hexahedral shape. For example, the main body 100 has a substantially rectangular parallelepiped shape, but portions corresponding to corners or vertices may have a round shape.

In the present embodiment, for better understanding and ease of description, two surfaces opposing each other in a thickness direction T are defined as a first surface 110 and a second surface 120, respectively, two surfaces opposing each other in a length direction L are defined as a first end surface 130 and a second end surface 140, respectively, and two surfaces opposing each other in a width direction W are defined as a first side surface 150 and a second side surface 160, respectively.

A length of the coil electronic component 1000 may mean, with reference to an optical microscope or scanning electron microscope (SEM) image for a cross-section of the length direction L—the thickness direction T at a central portion of the coil electronic component 1000 in the width direction W, a maximum value of lengths of a plurality of line segments that are parallel to the length direction L and connect two outermost boundaries facing each other in the length direction L of the coil electronic component 1000 shown in the cross-section image, respectively. Alternatively, the length of the coil electronic component 1000 may mean a minimum value of lengths of a plurality of line segments that are parallel to the length direction L and connect two outermost boundaries facing each other in the length direction L of the coil electronic component 1000 shown in the cross-section image, respectively. Alternatively, the length of the coil electronic component 1000 may mean an arithmetic mean value of lengths of at least two line segments among a plurality of line segments that are parallel to the length direction L and connect two outermost boundaries facing each other in the length direction L of the coil electronic component 1000 shown in the cross-section image, respectively.

A thickness of the coil electronic component 1000 may mean, with reference to an optical microscope or scanning electron microscope (SEM) image for a cross-section of the length direction L—the thickness direction T at the central portion of the coil electronic component 1000 in the width direction W, a maximum value of lengths of a plurality of line segments that are parallel to the thickness direction T and connect two outermost boundaries facing each other in the thickness direction T of the coil electronic component 1000 shown in the cross-section image, respectively. Alternatively, the thickness of the coil electronic component 1000 may mean a minimum value of lengths of a plurality of line segments that are parallel to the thickness direction T and connect two outermost boundaries facing each other in the thickness direction T of the coil electronic component 1000 shown in the cross-section image, respectively. Alternatively, the thickness of the coil electronic component 1000 may mean an arithmetic mean value of lengths of at least two line segments among a plurality of line segments that are parallel to the thickness direction T and connect two outermost boundaries facing each other in the thickness direction T of the coil electronic component 1000 shown in the cross-section image, respectively.

A width of the coil electronic component 1000 may mean, with reference to an optical microscope or scanning electron microscope (SEM) image for a cross-section of the length direction L—the width direction W at a central portion of the coil electronic component 1000 in the thickness direction T, a maximum value of lengths of a plurality of line segments that are parallel to the width direction W and connect two outermost boundaries facing each other in the width direction W of the coil electronic component 1000 shown in the cross-section image, respectively. Alternatively, the width of the coil electronic component 1000 may mean a minimum value of lengths of a plurality of line segments that are parallel to the width direction W and connect two outermost boundaries facing each other in the width direction W of the coil electronic component 1000 shown in the cross-section image, respectively. Alternatively, the width of the coil electronic component 1000 may mean an arithmetic mean value of lengths of at least two line segments among a plurality of line segments that are parallel to the width direction W and connect two outermost boundaries facing each other in the width direction W of the coil electronic component 1000 shown in the cross-section image, respectively.

Meanwhile, each of the length, width, and the thickness of the coil electronic component 1000 may be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. Meanwhile, when measuring the length of the coil electronic component 1000 by the micrometer measurement method, the length of the coil electronic component 1000 may mean a single measured value, or may mean an arithmetic average of a plurality of measured values. This may be equally applied to measuring the width and the thickness of the coil electronic component 1000.

The main body 100 constitutes an exterior of the coil electronic component 1000, and is a space where a magnetic path, which is a path through which the magnetic flux induced by the wound coil 200 passes, is formed, when current is applied to the wound coil 200 through the first and second external electrodes 500 and 600.

The main body 100 includes a base portion 101 and a cover portion 103. The base portion 101 may include a protrusion 105.

The base portion 101 may include a front surface 101a and a rear surface 101b, which are opposed in the width direction W, and a bottom surface 101c and a top surface 101d, which are opposed in the thickness direction T. The bottom surface 101c of the base portion 101 may comprise the second surface 120 of the main body 100.

The protrusion 105 may be disposed on the top surface 101d of the base portion 101, and the protrusion 105 may be integral with the base portion 101. The shape of the protrusion 105 viewed in the thickness direction T is not particularly limited, and may be a circle, an ellipse, or a polygon such as a triangle, a quadrangle, or the like. The protrusion 105 may have various known shapes that may be accommodated in the core of the wound coil 200. For example, the shape of the protrusion 105 may be the same as the cross-sectional shape of the core of the wound coil 200.

The base portion 101 may be formed by filling a mold with a magnetic material. The base portion 101 may also be formed by filling a mold with a composite material including a magnetic material and an insulating resin.

The cover portion 103 may be disposed on an upper side of the base portion 101 with reference to FIG. 1 to surround all surfaces of the base portion 101 except for the bottom surface 101c. Therefore, the cover portion 103 may comprise the first surface 110, the first end surface 130, the second end surface 140, the first side surface 150, and the second side surface 160 of the main body 100, and the base portion 101 and the cover portion 103 may comprise the second surface 120 of the main body 100 together. At least one of the base portion 101 and the cover portion 103 may include a magnetic material, and may comprise magnetic particles and an insulating resin interposed between magnetic particles.

The magnetic particles may be ferrite particles or metallic magnetic particles that exhibit magnetic properties.

The ferrite particles may include, for example, at least one of Mg—Zn-based, Mn—Zn-based, Mn—Mg-based, Cu—Zn-based, Mg—Mn—Sr-based, Ni—Zn-based spinel-type ferrites, Ba—Zn-based, Ba—Mg-based, Ba—Ni-based, Ba—Co-based, Ba—Ni—Co-based hexagonal ferrites, Y-based garnet-type ferrite and Li-based ferrite.

The metallic magnetic particles may be composed of two or more types of powder particles having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metallic magnetic particles may be at least one of pure iron, FeSi-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, and Fe—Cr—Al-based alloy.

The metallic magnetic particles may be amorphous or crystalline. For example, the metallic magnetic particles may be an Fe—Si—B—Cr-based amorphous alloy, but the present embodiment is not limited thereto. The metallic magnetic particles may have an average diameter of about 0.1 μm to 30 μm, but are not limited thereto. In this specification, the particle diameter or average diameter may mean a particle size distribution expressed by D₉₀, D₅₀, or the like.

The metallic magnetic particles may be two or more types of different metallic magnetic particles. Here, the metallic magnetic particles are different types of metallic magnetic particles, meaning that the metallic magnetic particles are distinct from each other in at least one of an average diameter, composition, component ratio, crystallinity, and shape.

The insulating resin may include epoxy, polyimide, liquid crystal polymer, etc. alone or in combination, but is not limited thereto.

A method of forming the main body 100 is not particularly limited. For example, the main body 100 may be formed by disposing magnetic sheets above and below the wound coil 200 and then compressing and curing the magnetic sheets. In another example, the main body 100 may also be formed by filling a mold with the magnetic powder to cover parts of the wound coil 200 and the first and second lead terminals 300 and 400 and then going through a pressing and curing process.

The wound coil 200 is embedded in the main body 100, exhibiting the characteristics of the coil electronic component 1000. For example, when the coil electronic component 1000 of the present embodiment is used as a power inductor, the wound coil 200 may serve to stabilize power source of an electronic device by maintaining an output voltage by storing an electric field as a magnetic field.

The wound coil 200 may have a shape in which a metal (e.g., copper (Cu) or silver (Ag)) wire coated with an insulating material is spirally wound. The wound coil 200 is not limited to a single wire, and may comprise a stranded wire or two or more wires.

The wound coil 200 may be an air coil, wound around the protrusion 105 of the base portion 101. The wound coil 200 may be a circular coil but is not limited thereto. For example, the wound coil 200 may be a variety of well-known coils such as a rectangular coil. As another example, the wound coil 200 may be a coil using a magnetic material or iron core ferrite as a core.

Cross-sections of individual wires of the wound coil 200 may have various well-known shapes such as a quadrangle, a circle, and an ellipse.

When the cross-sectional shape of each wire of the wound coil 200 is generally rectangular, it may have a first coil surface 210, a second coil surface 220, a third coil surface 230, and a fourth coil surface 240. The first coil surface 210 and the second coil surface 220 face each other along the thickness direction T of the main body 100. The third coil surface 230 and the fourth coil surface 240 connect the first coil surface 210 and the second coil surface 220 but face each other along the length direction L of the main body 100.

The wound coil 200 may comprise a plurality of layers. The wound coil 200 may include a first coil 201 and a second coil 203. The second coil 203 may be connected to the first coil 201 and forms a layer by being disposed above the first coil 201, that is, on a side toward the first surface 110 of the main body 100.

The number of turns of the first coil 201 and the number of turns of the second coil 203 may be the same or different.

The wound coil 200 is formed in a planar spiral shape and may have a plurality of turns. That is, the first coil 201 may have an innermost turn coil C1, at least one intermediate turn coil C2, and an outermost turn coil C3, in sequence from a midpoint of a length L1 of the main body 100 toward the first end surface 130. The second coil 203 may also have an innermost turn coil C1, at least one intermediate turn coil C2, and an outermost turn coil C3, in sequence from the midpoint of the length L1 of the main body 100 toward the second end surface 140.

A first lead-out portion 207 may extend from an end portion of the outermost turn coil C3 of the first coil 201, and a second lead-out portion 209 may extend from an end portion of the outermost turn coil C3 of the second coil 203.

An insulation layer IF may be disposed along a surface of each of the plurality of turns of the wound coil 200. The insulating film IF is for protecting and insulating the plurality of turns of each wound coil 200, and may include a known insulating material such as parylene. Any insulating material may be used in the insulation layer IF, and there is no particular limitation. For example, the insulation layer IF may be a polyurethane resin, a polyester resin, an epoxy resin, or a polyamideimide resin. The insulating film IF may be formed by a method such as vapor deposition, but is not limited thereto.

The wound coil 200 may include a spiral portion 205, the first lead-out portion 207 and the second lead-out portion 209, the first and second lead terminals 300 and 400.

The spiral portion 205 is a portion where a wire of the wound coil 200 is wound.

The first lead-out portion 207 and the second lead-out portion 209 each extend from the spiral portion 205. For example, the first and second lead-out portions 207 and 209 may extend from the rear surface 101b side of the base portion 101 through the front surface 101a toward the bottom surface 101c side. However, the present embodiment is not limited thereto and the first and second lead-out portions may extend in various directions.

The first lead terminal 300 extends from the first lead-out portion 207 in the width direction W, and has a shape that is drawn to the bottom surface 101c of the base portion 101. The second lead terminal 400 extends from the second lead-out portion 209 in the width direction W, and has a shape that is drawn to the bottom surface 101c of the base portion 101.

Grooves 107 and 108 may be formed in the base portion 101. For example, the grooves 107 and 108 may be formed across the front surface 101a, the bottom surface 101c, and the rear surface 101b of the base portion 101 on both sides in the length direction L. The grooves 107 and 108 may guide the lead terminals 300 and 400.

The grooves 107 and 108 may have a depth and width to accommodate the lead terminals 300 and 400. For example, depths of the grooves 107 and 108 may be less than or equal to thicknesses of the lead terminals 300 and 400, and widths of the grooves 107 and 108 may be greater than or equal to widths of the lead terminals 300 and 400.

However, the groove does not necessarily have to be formed on the base portion, and the groove may not be present depending on the method of forming the base portion or the arrangement of the lead terminals.

On the bottom surface 101c of the base portion 101, a recess portion 109 may be formed on a portion facing the protrusion 105. When the recess portion 109 is included, a metal particle filling rate of the protrusion 105 may be further increased by compression molding. The shape of the recess portion 109 viewed from the bottom side of the base portion 101 is not particularly limited, and may be in a shape of a circle, an ellipse, a polygonal such as a triangle or a quadrangle, or a belt.

The recess portion 109 exists between the first and second external electrodes 500 and 600. By providing the recess portion 109 between the first and second external electrodes 500 and 600, the path length between the first and second external electrodes 500 and 600 (distance along the bottom surface) may be increased, which may improve electrical insulation between the two external electrodes and increase reliability. In addition, by providing the recess portion 109 between the first and second external electrodes 500 and 600, when implemented on a substrate, the minimum distance between the substrate and the bottom surface of the base portion 101 may be increased, thereby increasing reliability. Since the insulation layer may be accommodated in the recess portion, the thickness of the coil electronic component may be reduced compared to the case where the recess portion is not formed.

A cross-sectional shape of the first lead terminal 300 along the length direction L of the main body 100 may be substantially quadrangular. That is, the cross section of the first lead terminal 300 has a first terminal surface 310, a second terminal surface 320, a third terminal surface 330, and a fourth terminal surface 340. The first terminal surface 310 and the second terminal surface 320 face each other along the thickness direction T of the main body 100, and the third terminal surface 330 and the fourth terminal surface 340 face each other along the length direction L of the main body 100.

The first terminal surface 310 may be embedded within the main body 100 and connected to the first lead-out portion 207 of the wound coil 200.

The second terminal surface 320 may be flush with the second surface 120 of the main body 100 or exposed from the second surface 120. At least a part of remaining surfaces connected to the second terminal surface 320 may be embedded within the main body 100. For example, the third terminal surface 330 and the fourth terminal surface 340 may be embedded in the interior of the main body 100.

A cross-sectional shape of the second lead terminal 400 along the length direction L of the main body 100 may also be generally quadrangular. That is, the cross-section of the second lead terminal 400 has a first terminal surface 410, a second terminal surface 420, a third terminal surface 430, and a fourth terminal surface 440. The first terminal surface 410 and the second terminal surface 420 face each other along the thickness direction T of the main body 100, and the third terminal surface 430 and the fourth terminal surface 440 face each other along the length direction L of the main body 100.

The first terminal surface 410 may be embedded within the main body 100 and connected to the second lead-out portion 209 of the wound coil 200.

The second terminal surface 420 may be flush with the second surface 120 of the main body 100 or exposed from the second surface 120. At least a part of remaining surfaces connected to the second terminal surface 420 may be embedded within the main body 100. For example, the third terminal surface 430 and the fourth terminal surface 440 may be embedded in the interior of the main body 100.

The first lead terminal 300 and the second lead terminal 400 may be spaced apart from each other along the length direction L of the main body 100 and parallel to each other.

The first and second external electrodes 500 and 600 may be disposed in the second surface 120 of the main body 100 of the coil electronic component 1000. The first and second external electrodes 500 and 600 are disposed on surfaces of the first and second lead terminals 300 and 400 of the wound coil 200 drawn out to the bottom surface 101c of the base portion 101, respectively. That is, the first and second external electrodes 500 and 600 are electrically connected to the first and second lead terminals 300 and 400 of the wound coil 200, respectively.

The first and second external electrodes 500 and 600 are not limited to being disposed directly on the surfaces of the first and second lead terminals 300 and 400 of the wound coil 200.

For example, the first and second external electrodes 500 and 600 may further extend from the surfaces of the first and second lead terminals 300 and 400 onto the bottom surface 101c of the base portion 101. In this case, the first and second external electrodes 500 and 600 may be disposed on the second surface 120 of the main body 100.

For another example, the first and second external electrodes 500 and 600 may further extend to first and second end surfaces 130 and 140 of the main body 100, respectively. In this case, the first external electrode 500 may be disposed across the second surface 120 and the first end surface 130 of the main body 100, and the second external electrode 600 may be disposed across the second surface 120 and the second end surface 140 of the main body 100.

For still another example, the first and second external electrodes 500 and 600 may further extend to the first and second end surfaces 130 and 140 and the first surface 110 of the main body 100, respectively. In this case, the first external electrode 500 may be disposed across the first surface 110, the second surface 120, and the first end surface 130 of the main body 100, and the second external electrode 600 may be disposed across the first surface 110, the second surface 120, and the second end surface 140 of the main body 100.

For still another example, the first and second external electrodes 500 and 600 may further extend to the first and second end surfaces 130 and 140, the first surface 110, and first and second side surfaces 150 and 160 of the main body 100, respectively. In this case, the first external electrode 500 may be disposed across the first surface 110, the second surface 120, the first end surface 130 and the first and second side surfaces 150 and 160 of the main body 100, and the second external electrode 600 may be disposed across the first surface 110, the second surface 120, the second end surface 140 and the first and second side surfaces 150 and 160 of the main body 100.

The first and second external electrodes 500 and 600 may be wholly or partially embedded in the base portion 101, and may protrude in the thickness direction T from the bottom surface 101c of the base portion 101.

The first and second external electrodes 500 and 600 may comprise a conductive material such as, copper (Cu), aluminum (Al), silver (Ag), tin (Sn), gold (Au), nickel (Ni), lead (Pb), chromium (Cr), titanium (Ti), an alloy thereof, or the like, but is not limited thereto.

The first and second external electrodes 500 and 600 may be formed by printing a conductive paste, depositing a conductive material, sputtering, or plating a conductive metal. For example, a conductive paste may include a metal such as silver (Ag), silver (Ag)-palladium (Pd), nickel (Ni), copper (Cu), and the like.

The first and second external electrodes 500 and 600 may comprise a plurality of layers.

For example, the first and second external electrodes 500 and 600 may include a first plated layer connected to both end portions of the wound coil 200, a conductive resin layer covering the first plated layer, a second plated layer covering the conductive resin layer, and a third plated layer covering the second plated layer, respectively. Here, the first plated layer serves as a pre-plated layer.

For another example, the first and second external electrodes 500 and 600 may include a conductive resin layer connected to both end portions of a wound coil, a first plated layer covering the conductive resin layer, and the second plated layer covering the first plated layer, respectively.

The first plated layer, the second plated layer, and the third plated layer of the first and second external electrodes 500 and 600 may include copper (Cu), nickel (Ni), tin (Sn), palladium (Pd), silver (Ag), gold (Au), platinum (Pt), tungsten (W), titanium (Ti), lead (Pb), an alloy thereof, or mixture thereof, respectively.

The conductive resin layers of the first and second external electrodes 500 and 600 may include resin and conductive metal. The resin included in the conductive resin layer is not particularly limited as long as it has bonding and shock absorption properties and may be mixed with conductive metal powder to form a paste. For example, the resin may include a phenolic resin, an acrylic resin, a silicone resin, an epoxy resin, or a polyimide resin. The conductive metal included in the conductive resin layer may include copper (Cu), silver (Ag), nickel (Ni), or a mixture thereof.

Referring to FIG. 4A and FIG. 4B, a first distance D1, which is an average distance between the first end surface 130 of the main body 100 and the outermost turn coil C3 of wound coils 200 and 201, measured along the length direction L of the main body 100 (i.e., along the line A-A′) at a half point of a thickness T1 of the main body 100, may be greater than or equal to 2% and smaller than or equal to 7.5% of the length L1 of the main body 100. For example, the first distance D1 may be an average distance between the third coil surface 230 of the outermost turn coil C3 of the wound coils 200 and 201 and the first end surface 130 of the main body 100.

If the first distance D1 is less than 2% of the length L1 of the main body 100, the wound coils 200 and 201 may be too close to the first end surface 130 of the main body 100, causing the coils 200 and 201 to be exposed to the outside of the main body 100. As will be described later, there is a case where the coil is disposed obliquely, unlike as shown in FIG. 3A and FIG. 3B, and in that case, the first distance D1 needs to exceed 2% of the length L1 of the main body 100 to prevent the coil from being exposed from the end surface of the main body.

When the first distance D1 exceeds 7.5% of the length L1 of the main body 100, a distance between the wound coils 200 and 201 and the first end surface 130 of the main body 100 becomes too large. When the first distance D1 becomes larger under the condition that the length L1 of the main body 100 is the same, the wound coil 200 is correspondingly more biased toward the center of the main body 100. As a result, the area of the magnetic path is reduced by a corresponding amount, which may cause a problem of reduced capacity. For example, a conventional coil electronic component having an average first distance of 8% may not sufficiently secure capacity versus volume, or may have limitations in terms of saturation current (Isat), direct current resistance (Rdc, copper loss) of the windings, number of turns in the coil, and the like.

In the coil electronic component according to the present embodiment, the problem of the conventional coil electronic component may be solved by setting the first distance D1 to 7.5% or less of the length L1 of the main body 100.

A second distance D2, which is a distance between the wound coil 200 and the first surface 110 of the main body 100, may be different from a third distance D3, which is a distance between first lead terminal 300 (or the second lead terminal 400) and the spiral portion 205 of the wound coil 200.

The second distance D2 may be a distance between the first coil surface 210 of the wound coils 200 and 203 and the first surface 110 of the main body 100. For example, the second distance D2 may be an arithmetic average of distances to the first surface 110 of the main body 100 measured at three points on the first coil surface 210.

The third distance D3 may be a distance be between the second coil surfaces 220 of the spiral portions 205 of the wound coils 200 and 201 and the first terminal surfaces 310 and 410 of the first and second lead terminals 300 and 400. For example, the third distance D3 may be an arithmetic average of distances to the first terminal surfaces 310 and 410 of the first and second lead terminals 300 and 400 measured at three points on the second coil surface 220.

The second distance D2 may be smaller than the third distance D3. In other words, when a region between the wound coil 200 and the first surface 110 of the main body 100 is referred to as a first cover layer 170 and a region between the spiral portion 205 and the first and second lead terminals 300 and 400 of the wound coil 200 is referred to as a second cover layer 180, the second cover layer 180 may be formed to be thicker than the first cover layer 170. In this case, under the condition that a thickness of the main body 100 is constant, the wound coil 200 may be closer toward the first surface 110 of the main body 100 and the spiral portion 205 of the wound coil 200 may be further away from the lead terminal. As the spiral portion 205 of the wound coil 200 becomes further away from the first and second lead terminals 300 and 400, the parasitic capacitance between the spiral portion 205 of the wound coil 200 and the first lead terminal 300 may decrease correspondingly. In other words, when the second cover layer 180 is made thicker than the first cover layer 170, the parasitic capacitance between the spiral portion 205 of the wound coil 200 and the first and second lead terminals 300 and 400 may be decreased.

Since the parasitic capacitance may be reduced in this way, the first and second lead terminals 300 and 400 may be disposed within the main body 100 in the length direction L. That is, the third terminal surface 330 of the first lead terminal 300 may be spaced apart from the first end surface 130 of the main body 100 by a fourth distance D4. The fourth distance D4 may be greater than the first distance D1. Like the first lead terminal 300, the third terminal surface 430 of the second lead terminal 400 may be spaced apart from the second end surface 140 of the main body 100 by the fourth distance D4. The fourth distance D4 may be greater than the first distance D1. In this case, the third terminal surfaces 330 and 430 of the first and second lead terminals 300 and 400 may be disposed further inward in the length direction L of the main body 100 than the third coil surface 230 of the outermost turn coil C3 of the wound coil 200. As such, the third terminal surfaces 330 and 430 of the first and second lead terminals 300 and 400 are disposed more inwardly than the outermost turn coil C3 of the wound coil 200 without being exposed to the outside of the first and second end surfaces 130 and 140 of the main body 100, a risk of short circuit may be reduced when the coil electronic component 1000 is mounted on a circuit board.

Meanwhile, although not shown in the drawings, the coil electronic component 1000 according to the present embodiment may further include an insulation layer on the second surface 120 of the main body 100 except for the area where the first and second external electrodes 500 and 600 are disposed. Alternatively, the insulation layer may be present on the second surface 120 of the main body 100 except for the portion where the first and second lead terminals 300 and 400 are exposed.

The insulation layer may be utilized as a resist when forming the first and second external electrodes 500 and 600 by electroplating, but is not limited thereto.

The insulation layer may be disposed on at least a portion of the first surface 110, the first end surface 130, the second end surface 140, the first side surface 150, and the second side surface 160 of the main body 100 to prevent electrical short circuit between other electronic components and the first and second external electrodes 500 and 600.

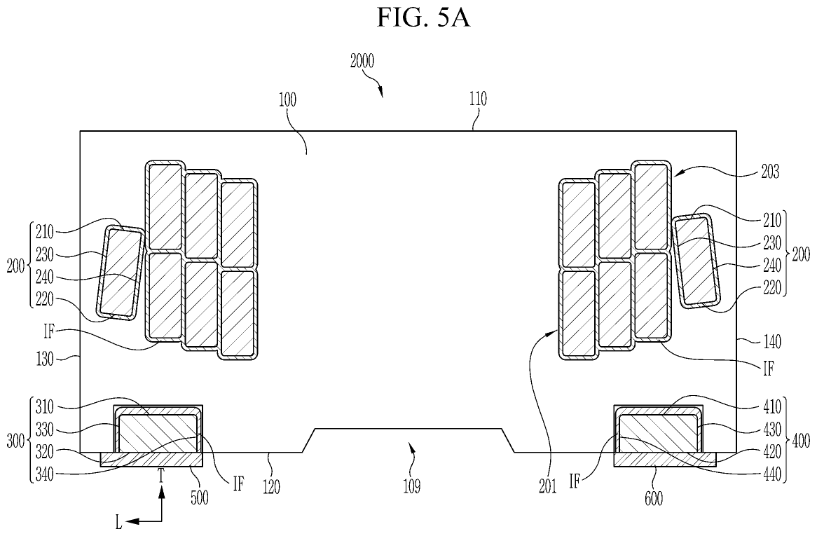

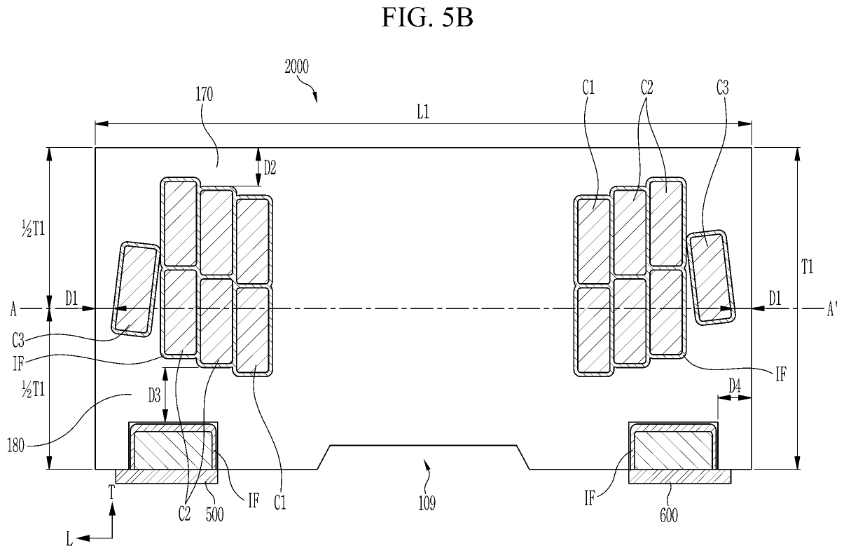

FIG. 5A and FIG. 5B are cross-sectional views schematically illustrating a coil electronic component according to another embodiment. Components of the coil electronic component shown in FIG. 5A and FIG. 5B that are the same as or correspond to components of the coil electronic component shown in FIG. 1 have been designated with the same reference numerals, and redundant descriptions of such components will be omitted.

Referring to FIG. 5A and FIG. 5B, a coil electronic component 2000 according to another embodiment includes a main body 100, a wound coil 200, a first lead terminal 300, and a second lead terminal 400.

The wound coil 200 may comprise a plurality of layers. The wound coil 200 may include a first coil 201 and a second coil 203. The second coil 203 may be connected to the first coil 201 and forms a layer by being disposed above the first coil 201, that is, on a side toward the first surface 110 of the main body 100.

The surfaces where the first coil 201 and the second coil 203 are in contact with each other may not form a horizontal plane. The innermost turn coil C1 of the first coil 201 and the innermost turn coil C1 of the second coil 203 are in contact with each other in the thickness direction T of the main body 100, and the intermediate turn coil C2 is disposed in the same way. However, the surface where the innermost turn coils C1 are in contact with each other and the surface where the intermediate turn coils C2 are in contact with each other may have different heights measured from the second surface 120 of the main body 100. That is, the corresponding surfaces have steps. Furthermore, the outermost turn coil C3 may be disposed obliquely to form an acute angle with the thickness direction T of the main body 100.

Referring to FIG. 5A and FIG. 5B, the first distance D1, which is an average distance between the first end surface 130 of the main body 100 and the outermost turn coil C3 of wound coils 200, 201, and 203, measured along the length direction L of the main body 100 (i.e., along the line A-A′) at a half point of the thickness T1 of the main body 100, may be greater than or equal to 2% and smaller than or equal to 7.5% of the length L1 of the main body 100. For example, the first distance D1 may be an average distance between the third coil surface 230 of the outermost turn coil C3 of the first coil 201 and the first end surface 130 of the main body 100. In addition, the first distance D1 may be an average distance between the fourth coil surface 240 of the outermost turn coil C3 of the second coil 203 and the second end surface 140 of the main body 100.

The second distance D2, which is a distance between the wound coil 200 and the first surface 110 of the main body 100, may be different from the third distance D3, which is a distance between the wound coil 200 and first lead terminal 300 (or the second lead terminal 400).

The second distance D2 may be a distance between the first coil surface 210 of the wound coil 200 and the first surface 110 of the main body 100. For example, the second distance D2 may be an arithmetic average of distances to the first surface 110 of the main body 100 measured at three points on the first coil surface 210.

The second distance D2 may be smaller than the third distance D3. In other words, when a region between the wound coil 200 and the first surface 110 of the main body 100 is referred to as a first cover layer 170 and a region between the spiral portion 205 and the first and second lead terminals 300 and 400 of the wound coil 200 is referred to as second cover layer 180, the second cover layer 180 may be formed to be thicker than the first cover layer 170. In this case, under the condition that a thickness of the main body 100 is constant, the wound coil 200 may be closer toward the first surface 110 of the main body 100 and the spiral portion 205 of the wound coil 200 may be further away from the lead terminal. As the spiral portion 205 of the wound coil 200 becomes further away from the first and second lead terminals 300 and 400, the parasitic capacitance between the spiral portion 205 of the wound coil 200 and the lead terminal 300 may decrease correspondingly. In other words, when the second cover layer 180 is made thicker than the first cover layer 170, the parasitic capacitance between the spiral portion 205 of the wound coil 200 and the first and second lead terminals 300 and 400 may be decreased.

Since the parasitic capacitance may be reduced in this way, the first and second lead terminals 300 and 400 may be disposed within the main body 100 in the length direction L. That is, the third terminal surface 430 of the second lead terminal 400 may be spaced apart from the second end surface 140 of the main body 100 by the fourth distance D4. Particularly, the fourth distance D4 may be greater than the first distance D1. Like a second lead terminal 400, the third terminal surface 330 of the first lead terminal 300 may be spaced apart from the first end surface 130 of the main body 100 by the fourth distance D4. The fourth distance D4 may be greater than the first distance D1. In this case, the third terminal surfaces 330 and 430 of the first and second lead terminals 300 and 400 may be disposed further inward in the length direction L of the main body 100 than the third coil surface 230 of the outermost turn coil C3 of the wound coil 200. As such, the third terminal surfaces 330 and 430 of the first and second lead terminals 300 and 400 are disposed more inwardly than the outermost turn coil C3 of the wound coil 200 without being exposed to the outside of the first end surface 130 of the main body 100, a risk of short circuit may be reduced when the coil electronic component 1000 is mounted on a circuit board.

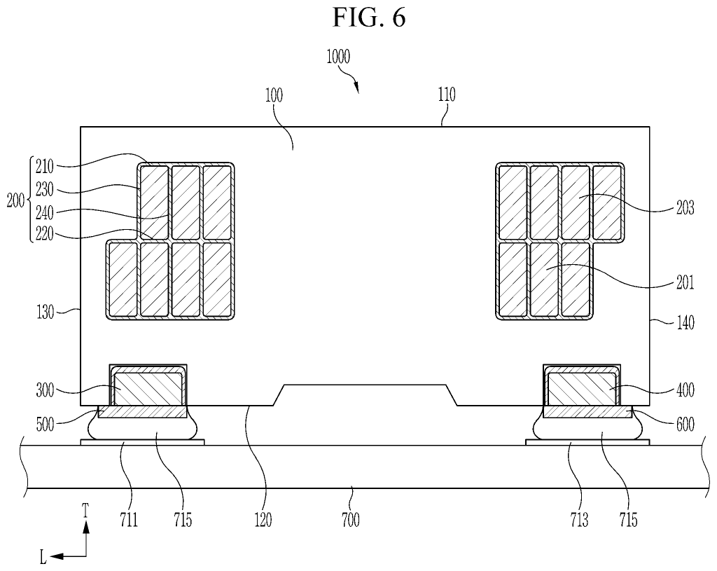

FIG. 6 is a schematic cross-sectional view illustrating the coil electronic component shown in FIG. 1 mounted on a board.

Referring to FIG. 6, the coil electronic component 1000 is connected to first and second electrode pads 711 and 713 through a conductive bonding member 715 disposed on an upper surface of a circuit board 700. That is, the coil electronic component 1000 may be mounted on the circuit board 700 through the first and second electrode pads 711 and 713.

The first and second electrode pads 711 and 713 may be spaced apart from each other on the upper surface of the circuit board 700. The first and second external electrodes 500 and 600 of the coil electronic component 1000 may be secured to the circuit board 700 using a conductive bonding member 715 while disposed to contact the first and second electrode pads 711 and 713. Accordingly, the coil electronic component 1000 may be electrically connected to the first and second electrode pads 711 and 713 of the circuit board 700. The conductive bonding member 715 may include, for example, a solder.

In the present embodiment, each of the first and second external electrodes 500 and 600 of the coil electronic component 1000 is mounted on the circuit board 700 by being fixed to the first and second electrode pads 711 and 713 by the conductive bonding member 715.

As the degree of integration of electronic components on the circuit board increases, the possibility of contact between adjacent electronic components also increases. In this case, if the external electrode of the electronic component is installed on the edge of the mounting surface, there is a high possibility of causing a short circuit with another adjacent external electrode.

The first and second external electrodes 500 and 600 of the coil electronic component 1000 according to the present embodiment is disposed in the inner side of the main body 100 in the length direction L without being exposed to the outside of the first end surface 130 and the second end surface 140 of the main body 100. Accordingly, when the coil electronic component 1000 is mounted on the circuit board 700, the possibility of causing a short circuit with another adjacent external electrode may be reduced.

Hereinafter, specific embodiments of the present disclosure are presented. However, the following described examples are only for illustrating the disclosure more specifically, and thus the scope of the present disclosure should not be limited by these examples.

### [Manufacture Example: Manufacture of Coil Electronic Components] (Example 1)

Coil electronic components having a ratio of the average distance D1 (hereinafter, referred to as “L-direction margin”) between the end surface of the main body in the length direction of the main body and the outermost turn coil of the wound coil to the length L1 of the main body of the coil electronic component is 2.0% are manufactured.

### Example 2

It is the same as Example 1 except that the ratio of L-direction margin D1 to the length L1 of the main body of the coil electronic component is 2.5%.

### Example 3

It is the same as Example 1 except that the ratio of L-direction margin D1 to the length L1 of the main body of the coil electronic component is 3.0%.

### Example 4

It is the same as Example 1 except that the ratio of L-direction margin D1 to the length L1 of the main body of the coil electronic component is 3.5%.

### Example 5

It is the same as Example 1 except that the ratio of L-direction margin D1 to the length L1 of the main body of the coil electronic component is 4.0%.

### Example 6

It is the same as Example 1 except that the ratio of L-direction margin D1 to the length L1 of the main body of the coil electronic component is 4.5%.

### Example 7

It is the same as Example 1 except that the ratio of L-direction margin D1 to the length L1 of the main body of the coil electronic component is 5.0%.

### Example 8

It is the same as Example 1 except that the ratio of L-direction margin D1 to the length L1 of the main body of the coil electronic component is 5.5%.

### Example 9

It is the same as Example 1 except that the ratio of L-direction margin D1 to the length L1 of the main body of the coil electronic component is 6.0%.

### Example 10

It is the same as Example 1 except that the ratio of L-direction margin D1 to the length L1 of the main body of the coil electronic component is 6.5%.

### Example 11

It is the same as Example 1 except that the ratio of L-direction margin D1 to the length L1 of the main body of the coil electronic component is 7.0%.

### Example 12

It is the same as Example 1 except that the ratio of L-direction margin D1 to the length L1 of the main body of the coil electronic component is 7.5%.

### Comparative Example 1

It is the same as Example 1 except that the ratio of L-direction margin D1 to the length L1 of the main body of the coil electronic component is 0.0%.

### Comparative Example 2

It is the same as Example 1 except that the ratio of L-direction margin D1 to the length L1 of the main body of the coil electronic component is 0.5%.

### Comparative Example 3

It is the same as Example 1 except that the ratio of L-direction margin D1 to the length L1 of the main body of the coil electronic component is 1.0%.

### Comparative Example 4

It is the same as Example 1 except that the ratio of L-direction margin D1 to the length L1 of the main body of the coil electronic component is 1.5%.

### Comparative Example 5

It is the same as Example 1 except that the ratio of L-direction margin D1 to the length L1 of the main body of the coil electronic component is 8.0%.

### Comparative Example 6

It is the same as Example 1 except that the ratio of L-direction margin D1 to the length L1 of the main body of the coil electronic component is 8.5%.

[Experimental Examples: Whether or not the Inductance of Coil Electronic Components being Defective]

After manufacturing 30 pieces of each of the coil electronic components of Embodiments 1 to 12 and Comparative Examples 1 to 6, the ratio (D1/L1) of L-direction margin D1 to the length L1 of the coil electronic component is measured, and it is checked whether the inductance Ls of the coil electronic component is within the acceptable range (0.33±10% uH, 0.297 uH-0.363 uH), and the results are summarized in Table 1.

TABLE 1

| | L1 | D1/L1 | D1 | Ls | |
|---|---|---|---|---|---|
| | (um) | (%) | (um) | (uH) | Result |
| Comparative | 2000 | 0.0 | 0 | 0.3786 | Not good |
| Example 1 | | | | | |
| Comparative | 2000 | 0.5 | 10 | 0.3747 | Not good |
| Example 2 | | | | | |
| Comparative | 2000 | 1.0 | 20 | 0.3705 | Not good |
| Example 3 | | | | | |
| Comparative | 2000 | 1.5 | 30 | 0.3551 | Not good |
| Example 4 | | | | | |
| Example 1 | 2000 | 2.0 | 40 | 0.3614 | Good |
| Example 2 | 2000 | 2.5 | 50 | 0.3566 | Good |
| Example 3 | 2000 | 3.0 | 60 | 0.3515 | Good |
| Example 4 | 2000 | 3.5 | 70 | 0.3463 | Good |
| Example 5 | 2000 | 4.0 | 80 | 0.341 | Good |
| Example 6 | 2000 | 4.5 | 90 | 0.3355 | Good |
| Example 7 | 2000 | 5.0 | 100 | 0.3298 | Good |
| Example 8 | 2000 | 5.5 | 110 | 0.324 | Good |
| Example 9 | 2000 | 6.0 | 120 | 0.3182 | Good |
| Example 10 | 2000 | 6.5 | 130 | 0.3122 | Good |
| Example 11 | 2000 | 7.0 | 140 | 0.3061 | Good |
| Example 12 | 2000 | 7.5 | 150 | 0.2999 | Good |
| Comparative | 2000 | 8.0 | 160 | 0.2936 | Not good |
| Example 5 | | | | | |
| Comparative | 2000 | 8.5 | 170 | 0.2872 | Not good |
| Example 6 | | | | | |

Referring to Table 1, it may be confirmed that the inductance of the coil electronic components manufactured in Comparative Examples 1 to 4 is excessively high and is out of the acceptable range (0.33±10% uH, 0.297 uH-0.363 uH). Meanwhile, it may be confirmed that the inductance of the coil electronic components manufactured in Examples 1 to 12 is within the acceptable range of (0.33±10% uH, 0.297 uH-0.363 uH). The inductance of coil electronic components manufactured in Comparative Examples 5 to 6 is excessively low and out of the acceptable range of (0.33±10% uH, 0.297 uH-0.363 uH), which was due to a relative decrease in the volume of the magnetic material in the core portion and the area of the magnetic path, resulting in a decrease in capacity. While the present disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000, 2000: coil electronic component
100: main body
101: base portion
103: cover portion
105: protrusion
107, 108: groove
109: recess portion
200: wound coil
201: first coil
203: second coil
205: spiral portion
207: first lead-out portion
209: second lead-out portion
300: first lead terminal
400: second lead terminal
110: first surface
120: second surface
130, 140: end surface
150: first side surface
160: second side surface
170: first cover layer
180: second cover layer
210: first coil surface
220: second coil surface
230: third coil surface
240: fourth coil surface
310, 410: first terminal surface
320, 420: second terminal surface
330, 430: third terminal surface
340, 440: fourth terminal surface
500, 600: external electrode
700: substrate
711, 713: electrode pad
715: conductive bonding member
C1: innermost turn coil
C2: intermediate turn coil
C3: outermost turn coil

What is claimed is:

1. A coil electronic component, comprising:
a main body comprising a magnetic material;
a wound coil of which at least a part is embedded in the main body; and
first and second lead terminals connected to both end portions of the wound coil, respectively,
wherein in a cross-section perpendicular to a width direction of the main body, a first distance D1, which is a distance between an end surface of the main body in a length direction and an outermost turn coil of the wound coil, measured along the length direction of the main body at a half point of a thickness T1 of the main body, is greater than or equal to 2% and smaller than or equal to 7.5% of a length L1 of the main body in the length direction.

2. The coil electronic component of claim 1, wherein:
the main body further comprises a first surface and a second surface spaced apart from each other along a thickness direction;
the wound coil comprises a first coil surface facing the first surface and a second coil surface facing the second surface of the main body;
the first and second lead terminals are disposed on the second surface of the main body; and
a second distance D2, which is a distance between the first surface and the first coil surface, is different from a third distance D3, which is a distance between the second coil surface and the first and second lead terminals.

3. The coil electronic component of claim 2, wherein the second distance D2 is smaller than the third distance D3.

4. The coil electronic component of claim 3, wherein:
each of the first and second lead terminals comprises a first electrode surface and a second electrode surface spaced apart from each other along the thickness direction of the main body; and
the second electrode surface is in contact with the second surface of the main body.

5. The coil electronic component of claim 4, wherein the second electrode surface is exposed from the second surface of the main body.

6. The coil electronic component of claim 4, wherein the third distance D3 is a distance between the second coil surface and the first electrode surface.

7. The coil electronic component of claim 4, wherein:
each of the first and second lead terminals comprises a third electrode surface that connects the first electrode surface and the second electrode surface; and
the third electrode surface faces the end surface of the main body in the length direction and is disposed apart from the end surface by a fourth distance D4.

8. The coil electronic component of claim 7, wherein the fourth distance D4 is larger than the first distance D1.

9. The coil electronic component of claim 4, wherein at least a part of remaining surfaces of the first and second lead terminals connected to the second electrode surface is embedded in an interior of the main body.

10. The coil electronic component of claim 3, wherein:
the wound coil comprises N turns, wherein N is a natural number greater than or equal to 1; and
the second distance D2 is an arithmetic average value obtained by measuring distances between three points on the first coil surface of a coil corresponding to each turn and the first surface of the main body.

11. The coil electronic component of claim 10, wherein the third distance D3 is an arithmetic average value obtained by measuring distances between three points on the second coil surface of a coil corresponding to each turn and the first and second lead terminals.

12. The coil electronic component of claim 11, wherein:
the wound coil comprises a first coil and a second coil that is connected to the first coil and stacked on the first coil;
the second distance D2 is a distance between the first surface of the main body and the first coil surface of the second coil; and
the third distance D3 is a distance between the second coil surface of the first coil and the first and second lead terminals.

13. The coil electronic component of claim 12, wherein the number of turns of the first coil and the number of turns of the second coil are the same.

14. The coil electronic component of claim 12, wherein the number of turns of the first coil and the number of turns of the second coil are different.

15. The coil electronic component of claim 1, wherein:
the magnetic material comprises metallic magnetic particles; and
the metallic magnetic particles comprise two or more powder particles having different compositions.

16. The coil electronic component of claim 15, wherein the metallic magnetic particles comprise iron (Fe).

17. The coil electronic component of claim 1, further comprising
first and second external electrodes disposed on surfaces of the first and second lead terminals, respectively, and electrically connected to the first and second lead terminals, respectively.

18. The coil electronic component of claim 17, wherein the first and second external electrodes further extend from the surfaces of the first and second lead terminals onto the second surface of the main body.

19. The coil electronic component of claim 17, wherein a recess portion is formed on the second surface of the main body in an area between the first and second external electrodes.

20. The coil electronic component of claim 10, wherein the wound coil comprises an innermost turn coil and an intermediate turn coil that are in contact with each other and have different heights measured from the second surface of the main body.
